(19) United States
(12) Patent Application Publication
(10) Pub. No.: US 2007/0270274 A1
(43) Pub. Date: Nov. 22, 2007

(54) Vehicular Differential Transmission Device

(76) Inventor: Bor-Yih Wu, Tainan (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/419,462

(22) Filed: May 19, 2006

(51) Int. Cl. F16H 48/06

(52) U.S. Cl. 475/230

(57) ABSTRACT

A vehicular differential transmission device includes a case, an input shaft, a transmission ring, a differential gear set, an output shaft and a clutch. The case sleeves is disposed on the input shaft and the output shaft. The differential gear set, the transmission ring, and the clutch sleeve are disposed on the output shaft. The input shaft links the transmission ring which in turn links the output shaft, and the clutch corresponds to the transmission ring. When the clutch locks the transmission ring, the differential gear set outputs a steady speed, on the contrary, when the clutch unlocks the transmission ring, the output shaft outputs a differential speed by means of the differential gear set. The case has a cap for connection of the input shaft, or otherwise, the input shaft may be coaxial with the output shaft and fixedly connected with a chain wheel.

### BACKGROUND OF THE INVENTION

1. Field of the Invention

The present invention relates to a vehicular differential transmission device applied to an all-terrain vehicle, a moving cart, or an electric mobility scooter, in particular to a device controlled by a clutch to output a steady speed or a differential speed, and a case having a cap to accommodate an input shaft or a chain wheel therein.

2. Description of the Prior Art

An all-terrain vehicle, a moving cart, or an electric mobility scooter uses power supply to drive wheels and also uses a differential device to control the wheels turning.

When turning the wheels, the wheels on one side will produce more friction, which requires a differential device to provide torque to drive the wheel. Under a special situation, the differential device has to be locked in order to provide power to the wheels on both sides at the same time.

A conventional differential device is disclosed in U.S. Pat. No. 5,551,929, which is hereby incorporated by reference in its entirety.

The foresaid vehicles use either a shaft input or a chain wheel input. Due to their different designs, their input transmissions cannot share with each other, which increases cost.

### SUMMARY OF THE INVENTION

It is a primary objective of the present invention to provide a vehicular differential transmission device, which uses a clutch to control the transmission output speed and a cap to accommodate either a shaft input or a chain wheel input, therefore it is relatively cost-effective.

It is a primary objective of the present invention to provide a vehicular differential transmission device, which controls an input shaft and an output shaft to transmit a steady speed or to produce a differential speed.

According to the present invention, there is provided a vehicular differential transmission device comprising a case, an input shaft, a transmission ring, a differential gear set, an output shaft and a clutch, said case enclosing said input shaft and said output shaft, said differential gear set, said transmission ring and said clutch being sleeved onto said output shaft, said input shaft linking said transmission ring which in turn linking said output shaft, and said clutch corresponding to said transmission ring, when said clutch engages with said transmission ring, said differential gear set being locked to output a steady speed, when said clutch detaches from said transmission ring, said output shaft outputting a differential speed by means of said differential gear set.

### BRIEF DESCRIPTION OF THE DRAWINGS

FIG. 1 is a top cross-sectional view of a first embodiment of the present invention with the movement in a linear status;

FIG. 2 is a top cross-sectional view showing operation of the first embodiment of the present invention in a differential speed status;

FIG. 3 is a top cross-sectional view of a second embodiment of the present invention with the movement in a linear status;

FIG. 4 is a cross-sectional view of a clutch of the first embodiment of the present invention;

FIG. 5 is a side cross-sectional view of the first embodiment of the present invention, showing a linear transmission movement; and

FIG. 6 is a side cross-sectional view of the first embodiment of the present invention, showing the operation of a differential device.

### DETAILED DESCRIPTION OF THE PREFERRED EMBODIMENTS

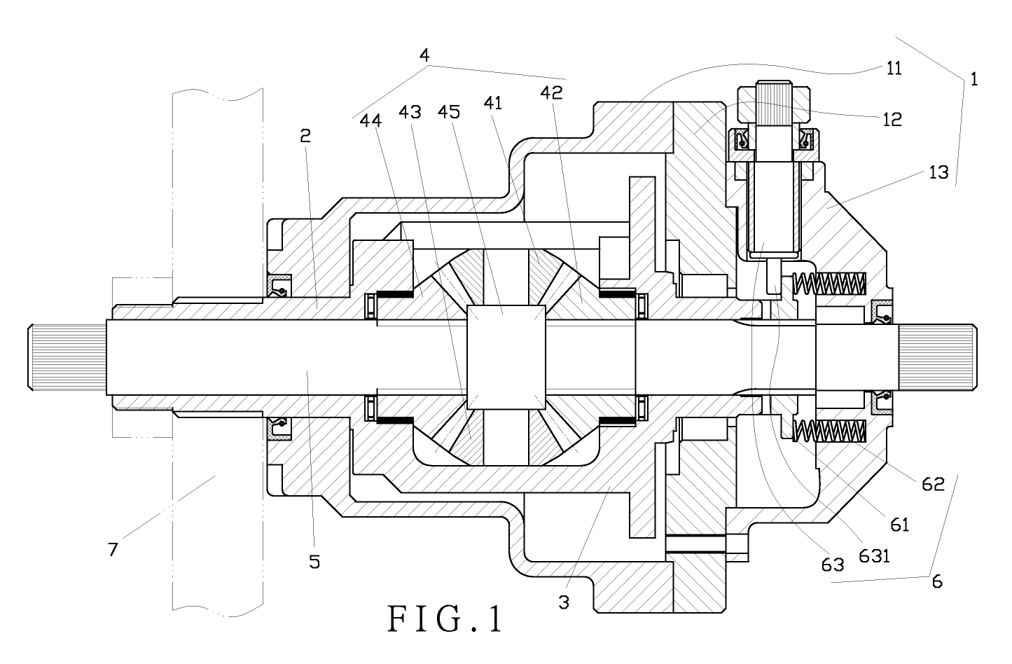

As shown in FIG. 1, a first embodiment of the present invention comprises a case 1, an input shaft 2, a transmission ring 3, a differential gear set 4, an output shaft 5, a clutch 6 and a chain wheel 7.

The case 1 includes a cap 11, a middle board 12 and a base 13. The case 11 is connected with the input shaft 2 and the output shaft 5, wherein the input shaft 2 and the output shaft 5 are coaxial. The output shaft 5 is covered with the differential gear set 4, the transmission ring 3 and the clutch 6, respectively. The output shaft 5 has two output ends and a center portion fixedly connected to the transmission ring 3. The input shaft 2 is fixedly connected with the chain wheel 7 and links the transmission ring 3 which then links the output shaft 5. The clutch 6 corresponds to the transmission ring 3.

The differential gear set 4 comprises four planet gears 41, 42, 43, 44 and a connecting ring 45. The connecting ring 45 is pivotally connected with the planet gears 41 and 43, while the connecting ring 45 and the planet gears 42 and 44 are sleeved onto the output shaft 5 and located at the center portion thereof. Upon assembling, the planet gear 41 meshes with the planet gears 42 and 44, and the planet gear 42 also meshes with the planet gears 41 and 43 at the same time.

The output shaft 5 has its two ends as output ends, respectively.

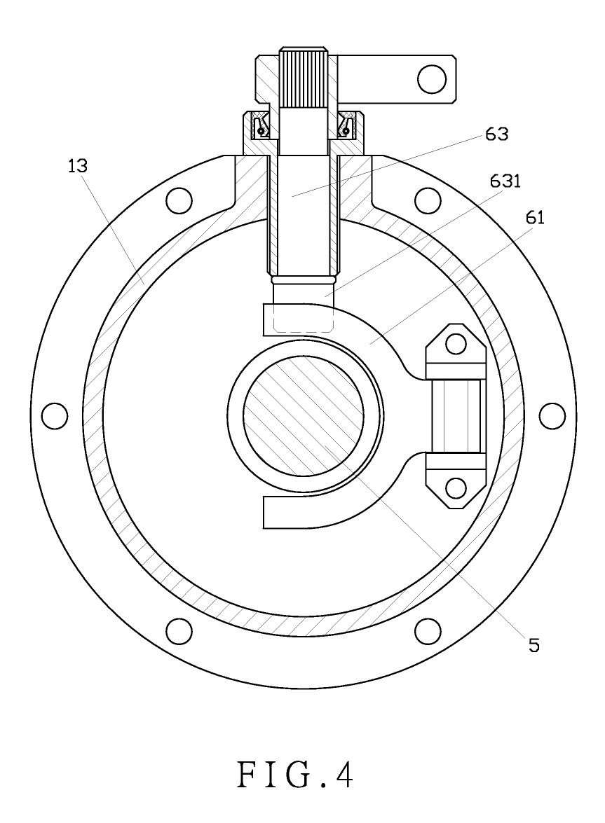

The clutch 6, as shown in FIGS. 1 and 4, comprises an engaging member 61, an elastic element 62, and a control stick 63. The engaging member 61 is sleeved onto the transmission ring 5. The elastic element 62 is set in between the engaging member 61 and the case 1, which makes the engaging member 61 to engage with the transmission ring 3. One end of the engaging member 61 is pivotally connected to the case 1, while the other end of the engaging member 61 engages with the transmission ring 3 and the elastic element 62 simultaneously. The control stick 62 is pivotally connected to the case 1 and comprises a cam board 631 to engage with the engaging member 61. By turning the control stick 63 (such as cable link), the cam board 631 is activated to engage with and to slide the engaging member 61. Thus the engaging member 61 releases the transmission ring 3.

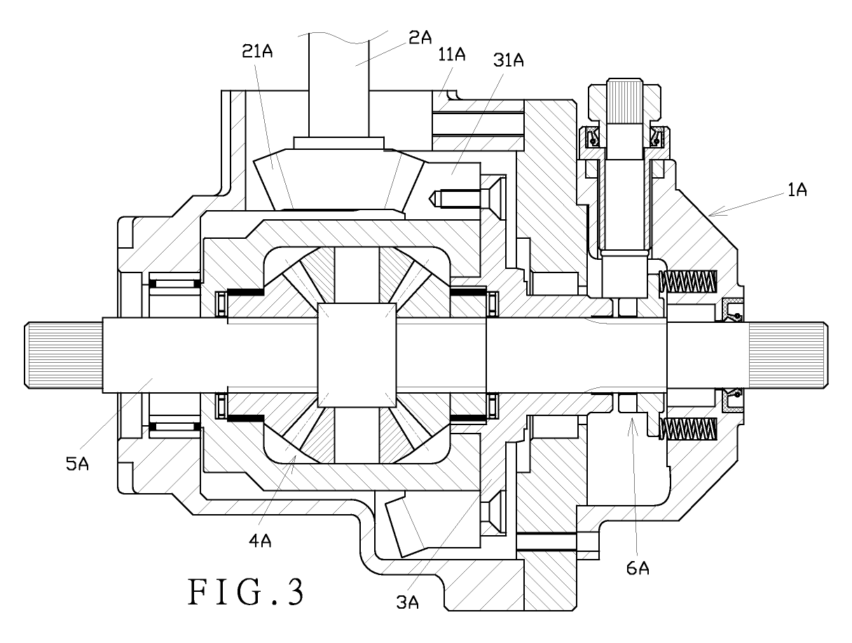

As shown in FIG. 3, a second embodiment of the present invention comprises a case 1A, an input shaft 2A, a transmission ring 3A, a differential gear set 4A, an output shaft 5A, and a clutch 6A. The case 1A includes a cap 11A having a hole to accommodate the input shaft 2A therein. The input shaft 2A comprises a planet gear 21A, and the transmission ring 3A comprises a planet gear 3A to mesh with the planet gear 21A of the input shaft 2A.

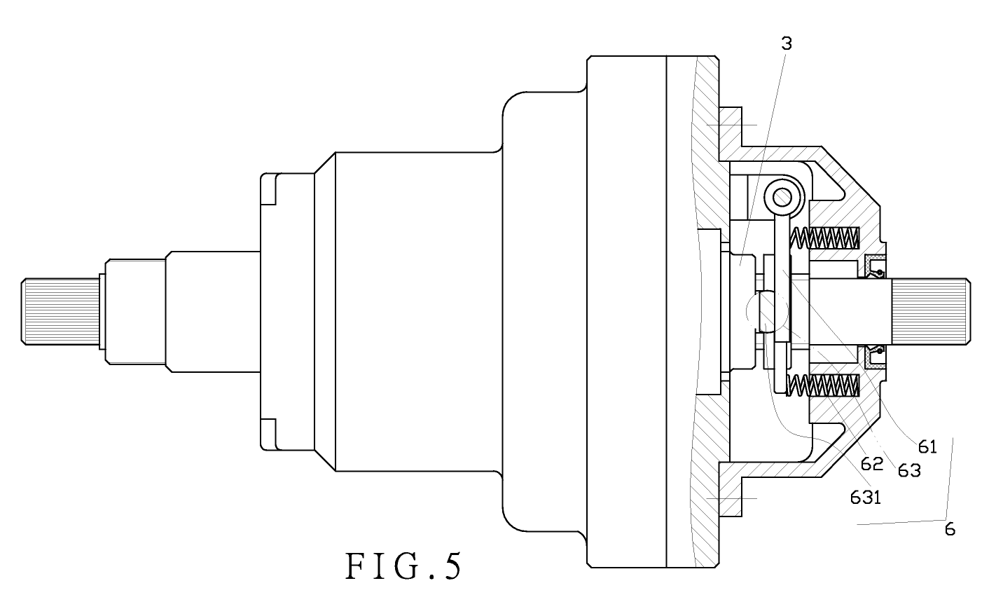

When the cam board 631 of the control stick 63 of the clutch 6 is turned to a flat position and is located next to the engaging member 61, the elastic element 62 will force the engaging member 61 to block the transmission ring 3 to lock the differential gear set 4 to output a steady speed, as shown in FIGS. 1 and 5.

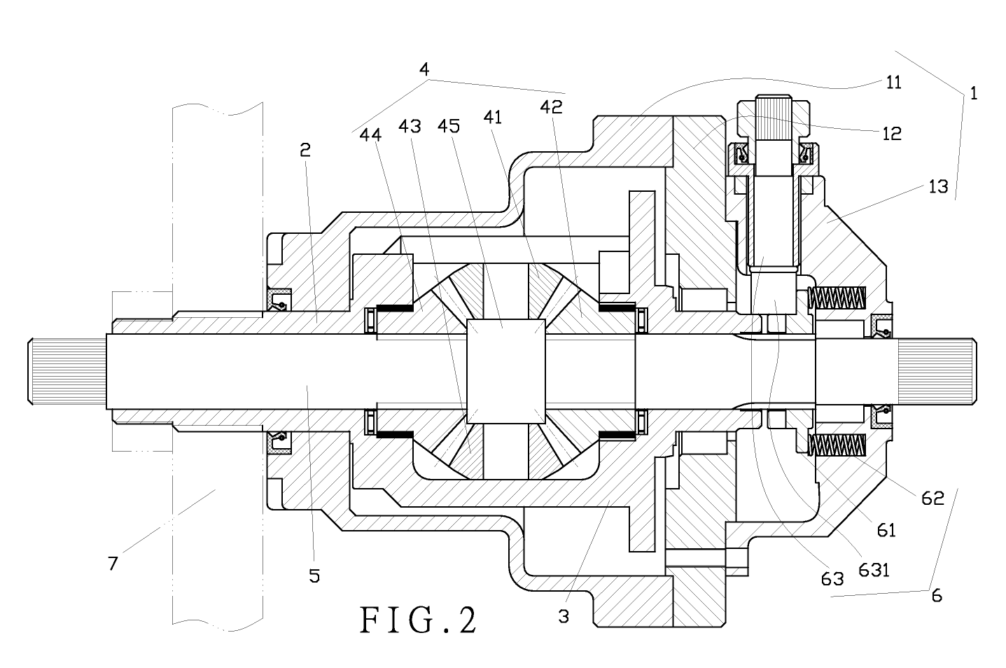

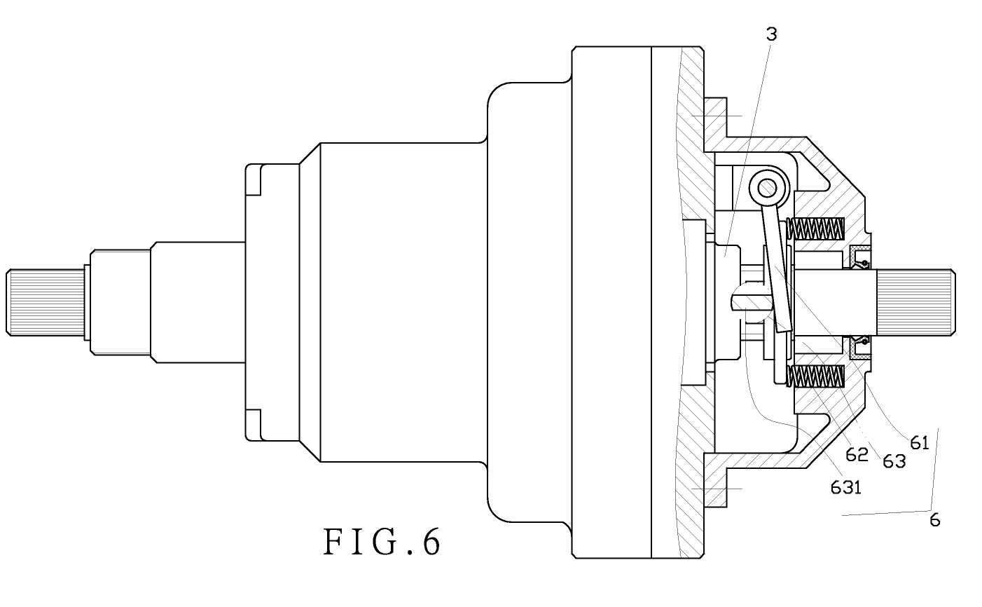

When the cam board 631 of the control stick 63 of the clutch 6 is turned to an angle (90 degrees in general), as shown in FIGS. 2 and 6, the cam board 631 engages with the engaging member 61 and the elastic element 62, which forces the engaging member 61 to detach from the transmission ring 3, and the output shaft 5 outputs a differential speed by means of the differential gear set 4.

Thus, specific embodiments and applications of a differential transmission device have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A vehicular differential transmission device comprising a case, an input shaft, a transmission ring, a differential gear set, an output shaft and a clutch, said case enclosing said input shaft and said output shaft, said differential gear set, said transmission ring and said clutch being sleeved onto said output shaft, said input shaft linking said transmission ring which in turn linking said output shaft, and said clutch corresponding to said transmission ring, when said clutch engages with said transmission ring, said differential gear set being locked to output a steady speed, when said clutch detaches from said transmission ring, said output shaft outputting a differential speed by means of said differential gear set.

2. The vehicular differential transmission device, as recited in claim 1, wherein said differential gear set comprises four planet gears and one connecting ring, said four planet gears corresponding with each other and meshing with each other, said connecting ring being pivotally connected with two said planet gears, while the other two said planet gears and said connecting ring being sleeved onto said output shaft and located at a center portion of said output shaft.

3. The vehicular differential transmission device, as recited in claim 1, wherein said clutch comprises an engaging member, an elastic element and a control stick, said engaging member comprising two ends, one end of said engaging member being pivotally connected with said case, said elastic element being disposed between the other end of said engaging member and said case, said engaging member engaging with said transmission ring, said control stick comprising a cam board and being pivotally connected to said case, said cam board of said control stick engaging with said engaging member, by turning said control stick, said cam board engaging with said engaging member to urge said engaging member to detach from said transmission ring.

4. The vehicular differential transmission device, as recited in claim 1, wherein said input shaft comprises a planet gear and said case comprises a cap to accommodate said input shaft therein, said transmission ring comprising a planet gear corresponding to and meshing with said planet gear of said input shaft.

5. The vehicular differential transmission device, as recited in claim 1, wherein said output shaft is fixedly connected to said transmission ring and said input shaft is fixedly connected to a chain wheel, said input shaft and said output shaft being coaxial.
